(19) United States
(12) Patent Application Publication
(10) Pub. No.: US 2024/0421858 A1
(43) Pub. Date: Dec. 19, 2024

(54) UE ASSISTED ON-DEMAND ROBUST PHASE CALIBRATION ALGORITHM FOR DISTRIBUTED MIMO BASED ON MULTI-PORT CSI-RS PMI FEEDBACK

(71) Applicant: Samsung Electronics Co., Ltd., Suwon-si (KR)

(72) Inventors: Thuy Van Nguyen, Plano, TX (US); Yang Li, Plano, TX (US); R A Nadisanka Perera Rupasinghe, McKinney, TX (US); Kyung-Joong Kim, Suwon (KR)

(21) Appl. No.: 18/604,406

(22) Filed: Mar. 13, 2024

Related U.S. Application Data
(60) Provisional application No. 63/521,288, filed on Jun. 15, 2023.

(51) Int. Cl. H04B 7/024; H04B 7/06

(52) U.S. Cl. CPC H04B 7/024; H04B 7/0626; H04B 7/0639

(57) ABSTRACT

A method of operating a network entity includes transmitting, via a first TRP and a second TRP, a first DL RS; receiving from a UE, based on the first DL RS, first CSI; determining, based on the first CSI, a calibrated quadrant; transmitting, via the first TRP and the second TRP, a second DL RS based on the calibrated quadrant; and receiving from the UE, based on the second DL RS, second CSI. The method further includes, for N iterations, determining, based on the (N+1)th CSI, an adjusted calibrated phase; transmitting, via the first TRP and the second TRP, an (N+2)th DL RS based on the adjusted calibrated phase; and receiving from the UE, based on the (N+2)th DL RS, (N+2)th CSI. The method further includes, after the N iterations, determining, based on a most recently received (N+2)th CSI, a converged calibrated phase.

### CROSS-REFERENCE TO RELATED APPLICATION) AND CLAIM OF PRIORITY

This application claims priority under 35 U.S.C. § 119 (e) to U.S. Provisional Patent Application No. 63/521,288 filed on Jun. 15, 2023. The above-identified provisional patent application is hereby incorporated by reference in its entirety.

### TECHNICAL FIELD

This disclosure relates generally to wireless networks. More specifically, this disclosure relates to apparatuses and methods for UE assisted on-demand robust phase calibration for distributed MIMO based on multi-port CSI-RS PMI feedback.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for UE assisted on-demand robust phase calibration for distributed MIMO based on multi-port CSI-RS PMI feedback.

In one embodiment, a network entity is provided. The network entity includes a memory, and a processor operably coupled to the memory. The processor is configured to perform a calibration operation. To perform a first stage of the calibration option, the processor is further configured to transmit, via a first TRP and a second TRP, a first downlink (DL) reference signal (RS); receive from a user equipment (UE), based on the first DL RS, first channel state information (CSI); determine, based on the first CSI, a calibrated quadrant; transmit, via the first TRP and the second TRP, a second DL RS based on the calibrated quadrant; and receive from the UE, based on the second DL RS, second CSI. To perform the first stage of the calibration option, the processor is further configured to, for N iterations, determine, based on the (N+1)th CSI, an adjusted calibrated phase; transmit, via the first TRP and the second TRP, an (N+2)th DL RS based on the adjusted calibrated phase; and receive from the UE, based on the (N+2)th DL RS, (N+2)th CSI. To perform the first stage of the calibration option, the processor is further configured to, after the N iterations, determine, based on a most recently received (N+2)th CSI, a converged calibrated phase.

In another embodiment, a UE is proved. The UE includes a processor configured to generate CSI, and a transceiver operably coupled to the processor. To perform a first stage of a calibration operation, the transceiver is configured to receive, via a first TRP and a second TRP, a first DL RS); transmit, based on the first DL RS, first CSI; receive, via the first TRP and the second TRP, a second DL RS based on a calibrated quadrant; and transmit, based on the second DL RS, second CSI. To perform the first stage of the calibration operation, the transceiver is further configured to, for N iterations, receive, via the first TRP and the second TRP, an (N+2)th DL RS based on an adjusted calibrated phase; and transmit, based on the (N+2)th DL RS, (N+2)th CSI.

In yet another embodiment, a method of operating a network entity is provided. The method includes performing a calibration operation. Performing a first stage of the calibration operation includes transmitting, via a first TRP and a second TRP, a DL RS; receiving from a UE, based on the first DL RS, first CSI; determining, based on the first CSI, a calibrated quadrant; transmitting, via the first TRP and the second TRP, a second DL RS based on the calibrated quadrant; and receiving from the UE, based on the second DL RS, second CSI. Performing the first stage of the calibration operation further includes, for N iterations, determining, based on the (N+1)th CSI, an adjusted calibrated phase; transmitting, via the first TRP and the second TRP, an (N+2)th DL RS based on the adjusted calibrated phase; and receiving from the UE, based on the (N+2)th DL RS, (N+2)th CSI. Performing the first stage of the calibration operation further includes, after the N iterations, determining, based on a most recently received (N+2)th CSI, a converged calibrated phase.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example network entity according to embodiments of the present disclosure;

FIG. 3 illustrates an example UE according to embodiments of the present disclosure;

FIG. 4 illustrates an example gNB according to embodiments of the present disclosure;

FIG. 5 illustrates an example of antenna blocks or arrays according to embodiments of the present disclosure;

FIG. 6 illustrates an example of distributed MIMO according to embodiments of the present disclosure;

FIG. 7 illustrates an example of distributed MIMO according to embodiments of the present disclosure;

FIG. 8 illustrates an example of a process for a calibration mechanism to enable phase or amplitude alignment among two or more gNBs according to various embodiments of the present disclosure;

FIGS. 9A-9B illustrate an example of a process 900 of UE-aided calibration with two TRPS according to various embodiments of the present disclosure;

FIG. 10 illustrates pseudo code for an example of a process of UE-aided calibration with two TRPS according to various embodiments of the present disclosure;

FIG. 11 illustrates an example of calibration triggering according to embodiments of the present disclosure;

FIG. 12 illustrates a method for a first phase of a UE assisted phase calibration for distributed MIMO performed by a network entity according to embodiments of the present disclosure; and

FIG. 13 illustrates a method for a second phase of a UE assisted phase calibration for distributed MIMO performed by a network entity according to embodiments of the present disclosure.

### DETAILED DESCRIPTION

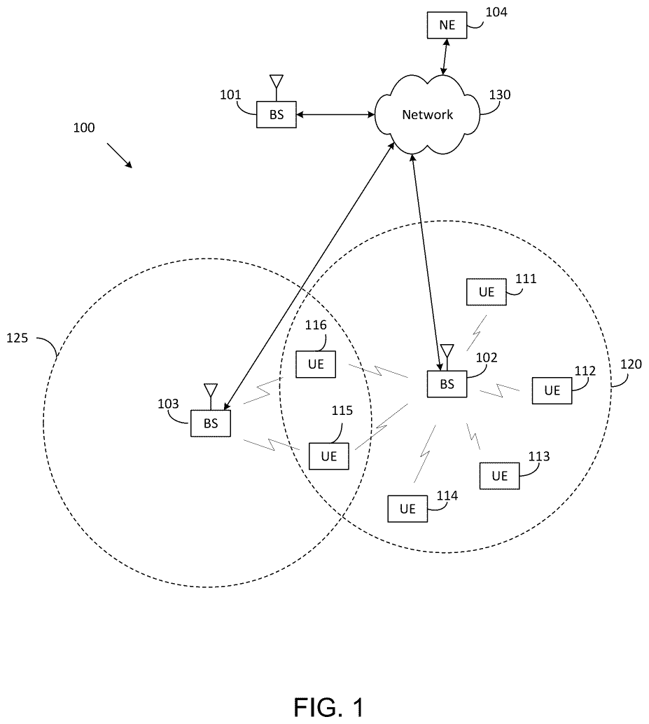

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band.

For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein:
[1] 3GPP TS 36.211 v16.4.0, “E-UTRA, Physical channels and modulation.” [2]
[2] 3GPP TS 36.212 v16.4.0, “E-UTRA, Multiplexing and Channel coding.” [3]
[3] 3GPP TS 36.213 v16.4.0, “E-UTRA, Physical Layer Procedures.”
[4] 3GPP TS 36.321 v16.3.0, “E-UTRA, Medium Access Control (MAC) protocol specification.”
[5] 3GPP TS 36.331 v16.3.0, “E-UTRA, Radio Resource Control (RRC) Protocol Specification.”
[6] 3GPP TS 38.211 v16.4.0, “NR, Physical channels and modulation.” [7]
[7] 3GPP TS 38.212 v16.4.0, “NR, Multiplexing and Channel coding.” [8]
[8] 3GPP TS 38.213 v16.4.0, “NR, Physical Layer Procedures for Control.” [9]
[9] 3GPP TS 38.214 v16.4.0, “NR, Physical Layer Procedures for Data.”
[10] 3GPP TS 38.215 v16.4.0, “NR, Physical Layer Measurements.”
[11] 3GPP TS 38.321 v16.3.0, “NR, Medium Access Control (MAC) protocol specification.”
[12] 3GPP TS 38.331 v16.3.1, “NR, Radio Resource Control (RRC) Protocol Specification.”

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the network entity (NE) 104, the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 and NE 104 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for UE assisted on-demand robust phase calibration for distributed MIMO based on multi-port CSI-RS PMI feedback. In certain embodiments, network entity 104 includes circuitry, programing, or a combination thereof, to support UE assisted on-demand robust phase calibration for distributed MIMO based on multi-port CSI-RS PMI feedback. In certain embodiments, one or more of the gNBs 101-103 includes circuitry, programing, or a combination thereof, to support UE assisted on-demand robust phase calibration for distributed MIMO based on multi-port CSI-RS PMI feedback in a wireless communication system.

Although FIG. 1 illustrates one example of a wireless network, various changes may be made to FIG. 1. For example, the wireless network could include any number of gNBs, network entities, and any number of UEs in any suitable arrangement. Also, the gNB 101 could communicate directly with any number of UEs and provide those UEs with wireless broadband access to the network 130. Similarly, each gNB 102-103 could communicate directly with the network 130 and network entity 104 and provide UEs with direct wireless broadband access to the network 130. Further, the gNBs 101, 102, and/or 103 and/or network entity 104 could provide access to other or additional external networks, such as external telephone networks or other types of data networks.

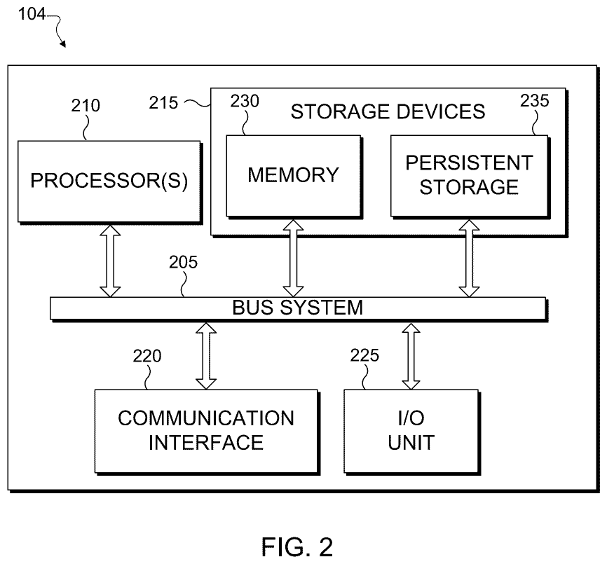

FIG. 2 illustrates an example network entity (NE) 104 according to embodiments of the present disclosure. The embodiment of the NE 104 illustrated in FIG. 2 is for illustration only. However, NEs come in a wide variety of configurations, and FIG. 2 does not limit the scope of this disclosure to any particular implementation of an NE.

The network entity 104 can represent one or more local computing resources, remote computing resources, clustered computing resources, components that act as a single pool of seamless computing resources, a cloud-based computing resource, a virtualized computing resource, and the like. The network entity 104 can be accessed by one or more of the gNBs 101-103 and UEs 111-116 of FIG. 1 or another network entity.

As shown in FIG. 2, the network entity 104 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry. In certain embodiments, the processor 210 can execute processes to support UE assisted on-demand robust phase calibration for distributed MIMO based on multi-port CSI-RS PMI feedback.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random-access memory or any other suitable volatile or non-volatile storage device(s). For example, the instructions stored in the memory 230 can include instructions for supporting phase and timing mis-match calibration in distributed MIMO. The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit operation instructions to another device such as one of gNBs 101, 102, and 103.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the network entity 104 occur via a network connection.

While the various components of network entity 104 are illustrated as discrete components such as processor 210, memory 230, and communications interface 220, all components or a subset of components of network entity 104 may be implemented as virtual components in a virtual resource, such as a virtual machine, a virtual server, software emulation, hardware emulation, and the like. In some embodiments, network entity 104 may be a virtual resource. In some embodiments, network entity 104 may be implemented entirely as computer program code operating on a separate apparatus.

In some circumstances, network entity 104 may be integrated into another apparatus. For example, network entity 104 may be integrated into gNB 102. For instance, gNB 102 may include hardware that performs the functions of network entity 104, may include virtual resources that perform the functions of network entity 104, may include software that performs the functions of network entity 104, and/or gNB 102 may perform the functions of network entity 104 as an inherent feature of gNB 102.

In some circumstances, a network entity may be implemented across multiple apparatuses. For example, network entity 104 may be implemented across gNB 102 and gNB 103 such that gNB 102 and gNB 103 form a single network entity 104.

Note that while FIG. 2 is described as representing the network entity 104 of FIG. 1, the same or similar structure could be used in one or more of the gNBs 101, 102, and 103.

Although FIG. 2 illustrates an example network entity, various changes can be made to FIG. 2. For example, various components in FIG. 2 could be combined, further subdivided, or omitted and additional components could be added according to particular needs. As a particular example, the processor 210 could be divided into multiple processors, such as one or more central processing units (CPUs).

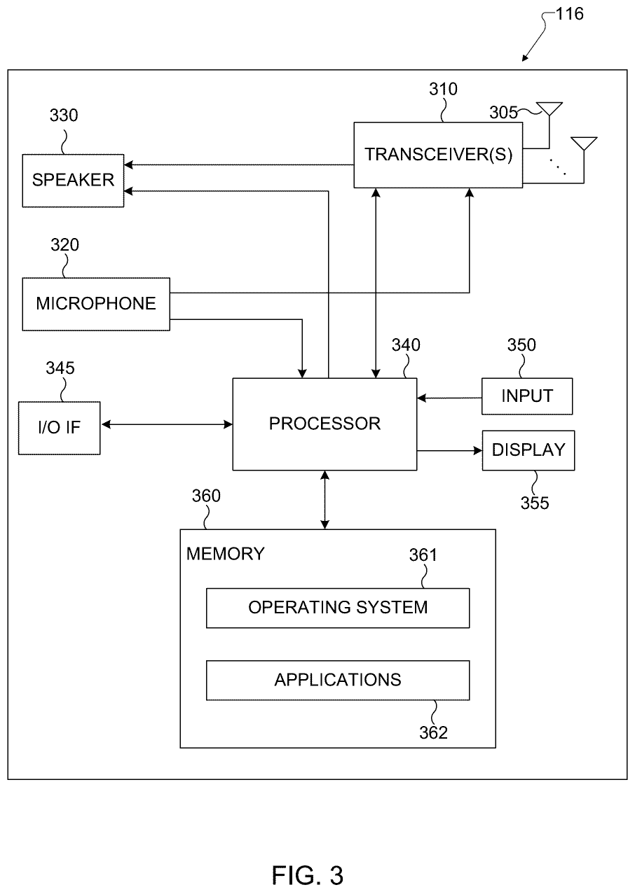

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for UE assisted on-demand robust phase calibration for distributed MIMO based on multi-port CSI-RS PMI feedback as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

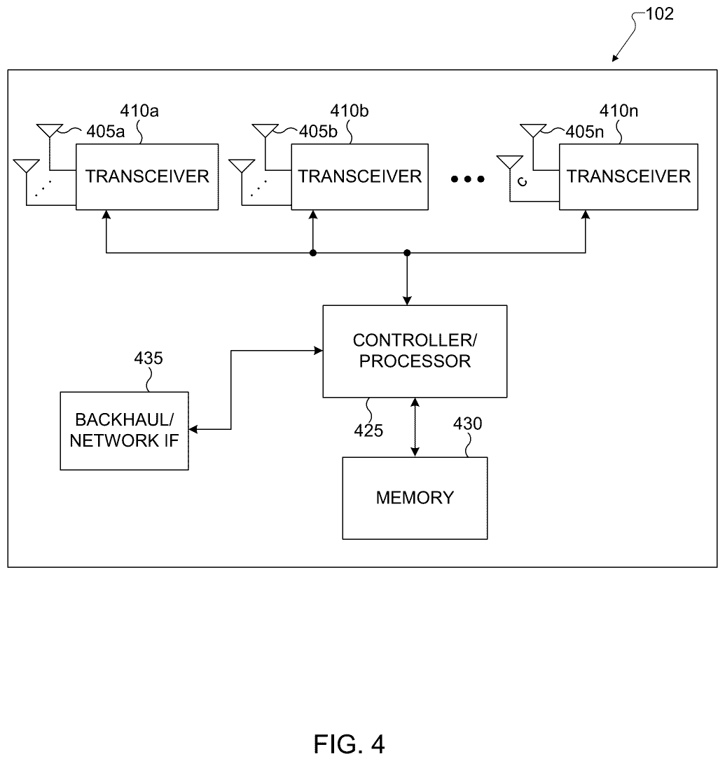

FIG. 4 illustrates an example gNB 102 according to embodiments of the present disclosure. The embodiment of the gNB 102 illustrated in FIG. 4 is for illustration only, and the gNBs 101 and 103 of FIG. 1 could have the same or similar configuration. However, gNBs come in a wide variety of configurations, and FIG. 4 does not limit the scope of this disclosure to any particular implementation of a gNB.

As shown in FIG. 4, the gNB 102 includes multiple antennas 405a-405n, multiple transceivers 410a-410n, a controller/processor 425, a memory 430, and a backhaul or network interface 435.

The transceivers 410a-410n receive, from the antennas 405a-405n, incoming RF signals, such as signals transmitted by UEs in the network 100. The transceivers 410a-410n down-convert the incoming RF signals to generate IF or baseband signals. The IF or baseband signals are processed by receive (RX) processing circuitry in the transceivers 410a-410n and/or controller/processor 425, which generates processed baseband signals by filtering, decoding, and/or digitizing the baseband or IF signals. The controller/processor 425 may further process the baseband signals.

Transmit (TX) processing circuitry in the transceivers 410a-410n and/or controller/processor 425 receives analog or digital data (such as voice data, web data, e-mail, or interactive video game data) from the controller/processor 425. The TX processing circuitry encodes, multiplexes, and/or digitizes the outgoing baseband data to generate processed baseband or IF signals. The transceivers 410a-410n up-converts the baseband or IF signals to RF signals that are transmitted via the antennas 405a-405n.

The controller/processor 425 can include one or more processors or other processing devices that control the overall operation of the gNB 102. For example, the controller/processor 425 could control the reception of UL channel signals and the transmission of DL channel signals by the transceivers 410a-410n in accordance with well-known principles. The controller/processor 425 could support additional functions as well, such as more advanced wireless communication functions. For instance, the controller/processor 425 could support beam forming or directional routing operations in which outgoing/incoming signals from/to multiple antennas 405a-405n are weighted differently to effectively steer the outgoing signals in a desired direction. Any of a wide variety of other functions could be supported in the gNB 102 by the controller/processor 425.

The controller/processor 425 is also capable of executing programs and other processes resident in the memory 430, such as an OS and, for example, processes to support UE assisted on-demand robust phase calibration for distributed MIMO based on multi-port CSI-RS PMI feedback as discussed in greater detail below. The controller/processor 425 can move data into or out of the memory 430 as required by an executing process.

The controller/processor 425 is also coupled to the backhaul or network interface 435. The backhaul or network interface 435 allows the gNB 102 to communicate with other devices or systems over a backhaul connection or over a network. The interface 435 could support communications over any suitable wired or wireless connection(s). For example, when the gNB 102 is implemented as part of a cellular communication system (such as one supporting 5G/NR, LTE, or LTE-A), the interface 435 could allow the gNB 102 to communicate with other gNBs over a wired or wireless backhaul connection. When the gNB 102 is implemented as an access point, the interface 435 could allow the gNB 102 to communicate over a wired or wireless local area network or over a wired or wireless connection to a larger network (such as the Internet). The interface 435 includes any suitable structure supporting communications over a wired or wireless connection, such as an Ethernet or transceiver.

The memory 430 is coupled to the controller/processor 425. Part of the memory 430 could include a RAM, and another part of the memory 430 could include a Flash memory or other ROM.

Although FIG. 4 illustrates one example of gNB 102, various changes may be made to FIG. 4. For example, the gNB 102 could include any number of each component shown in FIG. 4. Also, various components in FIG. 4 could be combined, further subdivided, or omitted and additional components could be added according to particular needs.

For a cellular system operating in low carrier frequency in general, a sub-1 GHz frequency range (e.g., less than 1 GHz) as an example, supporting large number of CSI-RS antenna ports (e.g., 32) or many antenna elements at a single location or remote radio head (RRH) is challenging due to a larger antenna form factor size needed considering carrier frequency wavelength than a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems. In particular, the MU-MIMO spatial multiplexing gains offered due to large number of CSI-RS antenna ports (such as 32) may not be achieved due to the antenna form factor limitation. One way to operate a system with large number of CSI-RS antenna ports at low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location. For example, the multiple distributed RRHs could be processed by a network entity, such as network entity 104 FIG. 1.

The present disclosure considers such a system (called distributed MIMO or multi-transmission-reception point (mTRP) or coherent joint transmission (CJT)) and includes methods to perform calibration for the RF receive/transmit antenna network of multiple RRHs/panels in the system to utilize DL/UL channel reciprocity, where the methods can be realized based on Type I single panel codebook and feedback design.

Calibration is an important issue for distributed MIMO in general. Massive MIMO base stations use an on-board coupling network and calibration circuits, which are referred to herein as the on-board calibration for brevity, to measure the gain and phase differences among transceivers in the same radio frequency (RF) unit in order to maintain the reciprocity between DL and UL channels in the TDD system. For the on-board calibration, one RF chain corresponding to one antenna port serves as a reference to other RF chains for other antenna ports. In the case of the distributed MIMO, such reference transceiver's signal needs to be shared between distributed RRHs/panels/modules, which are physically far apart. Using RF cables to distribute the reference is not preferable as it limits the deployment scenarios. In the distributed MIMO, the use of different local oscillators (Los) between distributed antenna modules imposes even more challenges in achieving calibration as the phase of Los could drift. Periodic calibration is needed to compensate for the phase drift as well.

The present disclosure describes over-the-air (OTA) signaling mechanisms and calculation algorithms for calibration among the RRHs/panels of distributed MIMO networks. One of the described mechanisms comprises UL RS transmission and UL channel estimation, (beamformed) DL RS transmission/reception based on UL channel estimation and calibration coefficient estimation, multiple CSI (RI/PMI/CQI) reporting, and gNB calculation based on reported CSI.

Although the present disclosure is described based on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

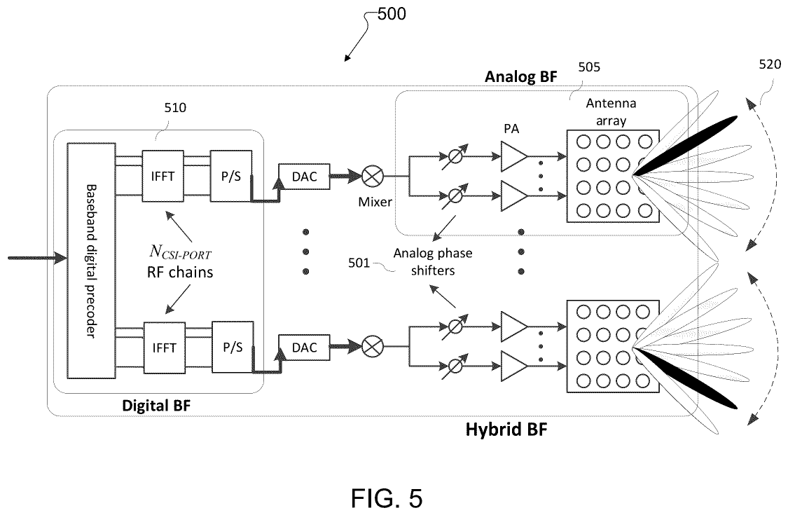

FIG. 5 illustrates an example of antenna blocks or arrays 500 according to embodiments of the present disclosure. The embodiment of the antenna blocks or arrays 500 illustrated in FIG. 5 is for illustration only. Different embodiments of antenna blocks or arrays 500 could be used without departing from the scope of this disclosure.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 5. In this case, one CSI-RS port is mapped onto a large number of antenna elements which can be controlled by a bank of analog phase shifters 501. One CSI-RS port can then correspond to one sub-array which produces a narrow analog beam through analog beamforming 505. This analog beam can be configured to sweep across a wider range of angles (520) by varying the phase shifter bank across symbols or subframes. The number of sub-arrays (equal to the number of RF chains) is the same as the number of CSI-RS ports NCSI-PORT. A digital beamforming unit 510 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

Although FIG. 5 illustrates one example of example antenna blocks or arrays 400, various changes may be made to FIG. 5. For example, the example antenna blocks or arrays 500 could include any number of each component shown in FIG. 5. Also, various components in FIG. 5 could be combined, further subdivided, or omitted and additional components could be added according to particular needs.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @100 m distance), larger number of and sharper analog beams (hence larger number of radiators in the array) will be needed to compensate for the additional path loss.

At lower frequency bands such as FRI or particularly sub-1 GHz band, on the other hand, the number of antenna elements cannot be increased in a given form factor due to large wavelength if a critical distance (≥λ/2) between two adjacent antenna elements is maintained in deployment scenarios. As an example, for the case of the wavelength size (λ) of the center frequency 600 MHz (which is 50 cm), it may require 4 m for uniform-linear-array (ULA) antenna panel of 16 antenna elements with the half-wavelength distance between two adjacent antenna elements. Considering a plurality of antenna elements is mapped to one digital port in practical cases, the required size for antenna panels at gNB to support a large number of antenna ports, e.g., 32 CSI-RS ports, becomes very large in such low frequency bands, and it leads to the difficulty of deploying 2-D antenna arrays within the size of a conventional form factor. This can result in a limited number of physical antenna elements and, subsequently CSI-RS ports, that can be supported at a single site and limit the spectral efficiency of such systems.

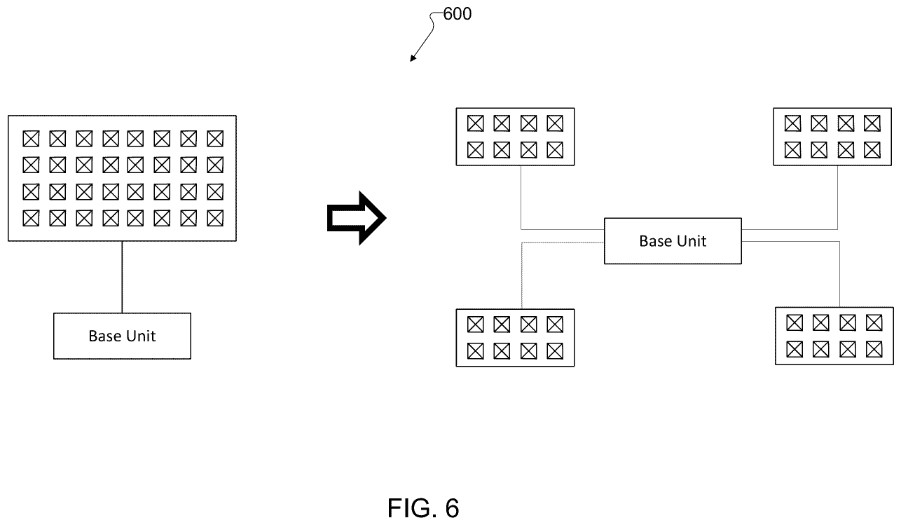

One possible approach to resolve the issue is to form multiple antenna panels (e.g., antenna modules, RRHs) with a small number of antenna ports instead of integrating all of the antenna ports in a single panel (or at a single site) and to distribute the multiple panels in multiple locations/sites (or RRHs), as illustrated in FIG. 6.

FIG. 6 illustrates an example of distributed MIMO 600 according to embodiments of the present disclosure. In the example of FIG. 6, distributed MIMO 600 is formed from multiple antenna panels, such as antenna modules or RRHs, with a small number of antenna ports instead of integrating all the antenna ports in a single panel or at a single site and distributing the multiple panels in multiple locations/sites or RRHs. The example of FIG. 6 may be implemented by a BS. For example, the example of distributed MIMO 600 may be implemented by one or more BSs such as BS 102. The MIMO 600 is for illustration only and other embodiments can be used without departing from the scope of the present disclosure.

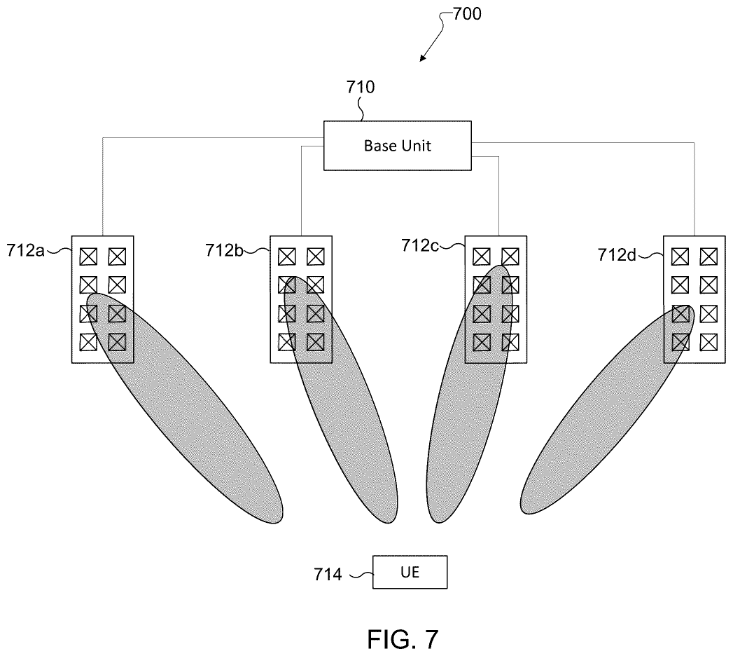

The multiple antenna panels at multiple locations can still be connected to a single base unit, and thus the signal transmitted/received via multiple distributed panels can be processed in a centralized manner through the single base unit, as illustrated in FIG. 7. In another embodiment, it is possible that multiple distributed antenna panels are connected to more than one base units, which communicates with each other and jointly supporting single antenna system.

FIG. 7 illustrates another example of distributed MIMO 700 according to embodiments of the present disclosure. In the example of FIG. 7, multiple antenna locations 712-712d are connected to a single base unit 710. The base unit 710 may process signals transmitted and received via antenna locations 712a-712d in a centralized manner. For example, base unit 710 may process signals transmitted and received to UE 714. The example of FIG. 7 may be implemented by a BS. For example, the distributed MIMO 700 may be implemented by one or more BSs such as BS 102. The example of distributed MIMO 700 is for illustration only and other embodiments can be used without departing from the scope of the present disclosure.

As illustrated, multiple antenna panels at multiple locations can still be connected to a single base unit (e.g., in one of BSs 101-103). Thus, the signal transmitted/received via multiple distributed panels can be processed in a centralized manner through the single base unit. In another embodiment, multiple distributed antenna panels are connected to more than one base unit, which communicates with each other while jointly supporting the single antenna system.

In time division duplexing (TDD), a common approach to acquire DL channel state information is to exploit UL channel estimation through receiving UL RSs for example, a sounding reference signal (SRS), sent from a UE. By using the channel reciprocity in TDD systems, the UL channel estimation itself can be used to infer DL channels. This favorable feature enables the network (NW) to reduce the training overhead significantly. However, due to the RF impairment at the transmitter and receiver, directly using the UL channels for DL channels is not accurate and it may require a periodic calibration process among receive and transmit antenna ports of the RF network at NW. In general, the NW has an on-board calibration mechanism in its own RF network to calibrate its antenna panels having a plurality of receiver/transmitter antenna ports, to enable DL/UL channel reciprocity in channel acquisition. The on-board calibration mechanism can be performed via small-power RS transmission and reception from/to the RF antenna network of the NW and thus it can be done by the NW's implementation in a confined manner, i.e., that does not interfere with other entities. However, it becomes difficult to perform the on-board calibration in distributed MIMO systems due to the distribution of the panels/RRHs over a wide region. Thus, over-the-air (OTA) signaling mechanisms are provided to calibrate receive/transmit antenna ports among multiple RRHs/panels far away in distributed MIMO.

This disclosure includes UE-assisted calibration mechanisms for distributed MIMO systems. A high-level description of multiple CSI reporting was briefly introduced in U.S. application Ser. No. 17/673,641 filed on Feb. 16, 2022, which is incorporated by reference in its entirety. Although low-band TDD systems are exemplified for motivation purposes, the present disclosure can be applied to any frequency band in FRI and/or FDD systems.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can comprise one or multiple slots) or one slot.

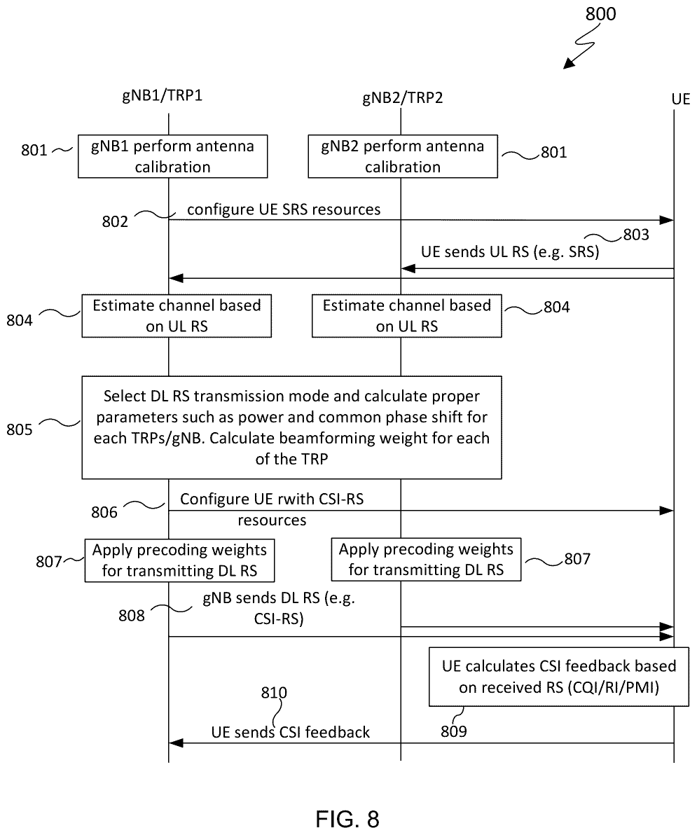

FIG. 8 illustrates an example of a process 800 for signal flow for the calibration mechanism of the disclosed technology that aims to enable phase or amplitude alignment among two or more gNBs according to various embodiments of the present disclosure. The embodiment of the signal flow of FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a signal flow for the calibration mechanism of the disclosed technology could be used without departing from the scope of this disclosure.

In the Example of FIG. 8 the process 800 may be implemented by UE 116 and gNBs 102 and 103. Without loss of generality, FIG. 8 discusses two TRP cases, yet the method described here can be generated for more than two TRPs. Note that in the present disclosure, the case of an antenna port of the UE 116 is discussed and it can be extended to the case of multiple antenna ports of the UE 116 by introducing another dimension. It is sufficient to discuss a single antenna port at UE 116 side because embodiments of the present disclosure provide methods for calibrating distributed antenna panels at the NW side.

The case of an antenna port of the UE 116 is provided and it can be extended to the case of multiple antenna ports of the UE 116 by introducing another dimension. Embodiments describing a single antenna port at UE 116 side are discussed since various embodiments provide methods for distributing antenna panels at the NW side.

The process begins in step 801, the two TRPs 102 and 103 that participate in this across TRP calibration perform antenna calibration within the TRPs, respectively. After the antenna calibration process for the two TRPs, in step 802, gNB 102 will configure SRS resources for the UE 116. In one embodiment, one of the gNB (e.g., serving gNB) configures SRS resources to the UE 116. In another embodiment, the multiple TRPs 102 and 103 configure SRSs respectively to the UE 116.

In an additional embodiment, the UE 116 is configured/triggered with L UL RSs or UL RS resource sets, e.g., SRS resource or resource sets. In one example, an RRH can be associated with a collection of SRS ports and associated with one SRS resource. In another example, a TRP 102 can be associated with a collection of SRS resources and can be associated with an SRS resource set. In yet another embodiment, the UE 116 is configured/triggered with L UL RSs or UL RS resource sets, e.g., SRS resource or resource sets. In one example, L=1. In another example, L=N_{TRP}, where N_{TRP} is the number of TRPs that NW may want to calibrate. In one example, M=1. In another example, M=L. In another example, M≥L. In another example, M≤L. In another example, M=N_{TRP}. Here, the linkage information between UL RS resources/resource sets and DL RS resources/resource sets is incorporated into the UL RS triggering/configuring request, and thus the UE 116 can expect to receive DL RSs/resource sets under the linkage.

In another variation, the UE 116 is configured/triggered with L UL RS resource sets, e.g., SRS resource or resource sets. Each DL RS resource set could be associated with a different RRH. Here, the linkage information between UL RS resources/resource sets and DL RS resources/resource sets is incorporated into the UL RS triggering/configuring request, and thus the UE 116 can expect to receive DL RSs/resource sets under the linkage.

In yet another variation, the UE 116 is configured/triggered with L UL RS resource sets, e.g., SRS resource or resource sets. In one example, L=1, and each DL RS resource set could be associated with a different RRH. Here, the linkage information between UL RS resources/resource sets and DL RS resources/resource sets is incorporated into the UL RS triggering/configuring request, and thus the UE 116 can expect to receive DL RSs/resource sets under the linkage.

Moving forward, in step 803, the UE 116 then sends the UL RS, e.g., SRS, to gNB1 and gNB2. In one embodiment, the UE 116 sends a SRS that can be received at both TRP 102 and 103. In another embodiment, the UE 116 sends multiple SRS which can be received by the multiple TRPs, respectively. In yet embodiment, the UE is configured to transmit one or multiple UL RSs, e.g., SRS, for NW to estimate UL channels.

The following, in step 804, involves gNB 102 and gNB 103 estimating the UL channel based on the UE 116's UL RS from step 803. In one embodiment, multiple TRPs on the NW can estimate UL channels via the UL RS reception. For example, the UL channels for a given resource, RE/RB/RBG or any other given resource unit, that are estimated at each RRH/panel i can be expressed as hᵢ^{UL}=Rᵢgᵢt^{m}, where Rᵢ is an Nᵢ×Nᵢ diagonal matrix with complex diagonal elements r₁, . . . , r_{N}_{ᵢ}; and indicates the RF impairment at the receiver antenna ports of TRP i, and gᵢ is an Nᵢ×1 channel vector for the UL physical propagation channels between UE 116 and RRH/panel i and t^{m} is a complex scalar value that corresponds to the RF impairment at a transmitter antenna port m of the UE 116.

Note that the UL channel hᵢ^{UL} is not the same as the actual UL propagation channels due to the RF impairment of the receiver and transmitter. The corresponding DL channels can be expressed as (hᵢ^{DL})^{H}=r^{m}gᵢ^{H} Tᵢ, where Tᵢ is an Nᵢ×Nᵢ diagonal matrix with complex diagonal elements t₁, . . . , t_{N}_{ᵢ} and indicates the RF impairment at the transmitter antenna ports of TRP i, and gᵢ^{H} is an 1×Nᵢ channel vector for the DL physical propagation channels between UE 116 and TRP i, and r^{m} is a complex scalar value that corresponds to the RF impairment at the receiver antenna port of the UE 116. The DL physical propagation channels are, or can be regarded to be, the same as the UL physical propagation channels within the coherence time in TDD systems.

Note that in step 801, the NW can compute calibration coefficients

$${C}_{i} = \frac{1}{{γ}_{i}} {T}_{i}^{- 1} {R}_{i}$$

for the antenna ports within the TRP i, whereof γᵢ≠0 is an arbitrary complex reference value for TRP i, and apply the calibration coefficient matrix in the RF network of TRP i to get a scaled version of the DL channel from the UL channel, i.e.,

$${( {h}_{i}^{UL} )}^{H} {C}_{i}^{- 1} = {γ}_{i} {t}^{m} {g}_{i}^{H} {T}_{i} . \qquad ( 1 )$$

Note that the calibration coefficients Cᵢ can be computed via on-board calibration per TRP, and γᵢ is not known to the NW.

Progressing through example process 800, in step 805, where gNB 102 and gNB 103 select the DL RS transmission mode based on UL channel estimation. In one embodiment, based on the UL channel estimation, the NW applies beamforming or precoding for DL RS transmissions from multiple TRPs and transmits DL RSs using the beamforming. The example process 800 proceeds in step 806, gNB 102 and gNB 103 configure the UE 116 with CSI-RS resources.

Having completed the previous step, in step 807, gNB 102 and gNB 103 apply precoding weights for transmitting DL RS to UE 116. In one embodiment, based on the UL channel estimation, the NW applies beamforming or precoding for DL RS transmissions from multiple TRP. In another embodiment, the UE 116 is configured/triggered with L UL RS resource sets, e.g., SRS resource or resource sets, each of which is linked with, or associated with, a DL RS resource set, e.g., a CSI-RS resource set. Each DL RS resource set could be associated with a different RRH. Here, the linkage information between UL RS resources/resource sets and DL RS resources/resource sets is incorporated into the UL RS triggering/configuring request, and thus the UE 116 can expect to receive DL RSs/resource sets under the linkage.

At this point, in step 808, gNB1 and gNB2 sends DL RS, e.g., CSI-RS, to the UE 116. In one embodiment, the multiple TRPs transmit DL RS using beamforming, and the UE 116 is configured/triggered to receive the DL RS. In one example, the DL RS transmissions are performed within the coherence time of the UL RS transmission beforehand.

In another embodiment, the NW performs DL RS transmissions from multiple TRPs each with matched-filter (MF) beamforming or conjugate beamforming, i.e., wᵢ=αᵢ(γᵢt^{m})*Tᵢ^{H}gᵢ, based on the UL channel estimation applied with calibration coefficient matrix as shown in equation (1), where αᵢ>0 is a designed/calculated phase and/or amplitude offset and (A)* is conjugate of A. The MF beamforming can enable UE 116 to estimate the resultant signal value:

$${( {h}_{i}^{DL} )}^{H} {w}_{i} = {r}^{m} {g}_{i}^{H} {T}_{i} {{α}_{i} ( {γ}_{i} {t}^{m} )}^{*} {T}_{i}^{H} {g}_{i} = {α}_{i} {{γ}_{i}^{*} ( {t}^{m} )}^{*} {r}^{m} {‖ {T}_{i}^{H} {g}_{i} ‖}^{2} \qquad ( 2 )$$

for DS RS transmission from TRP i. Note that the UE 116 now receives an equivalent channel for RSs sent from all TRPs

$$[ {α}_{1} {{γ}_{1}^{*} ( {t}^{m} )}^{*} {r}^{m} {‖ {T}_{1}^{H} {g}_{1} ‖}^{2} , … , {α}_{K} {{γ}_{K}^{*} ( {t}^{m} )}^{*} {r}^{m} {‖ {T}_{K}^{H} {g}_{k} ‖}^{2} ]$$

Normalized by the phase and amplitude of the first TRP:

$${h}_{eff} = [ 1 , \frac{{α}_{2} {γ}_{2}^{*} {‖ {T}_{2}^{H} {g}_{2} ‖}^{2}}{{α}_{1} {γ}_{1}^{*} {‖ {T}_{1}^{H} {g}_{1} ‖}^{2}} , … , \frac{{α}_{K} {γ}_{K}^{*} {‖ {T}_{K}^{H} {g}_{K} ‖}^{2}}{{α}_{1} {γ}_{1}^{*} {‖ {T}_{1}^{H} {g}_{1} ‖}^{2}} ] \qquad ( 3 )$$

Note that the above derivation is based on a single frequency point for simplicity, but the general principle can also be applied to a multi-carrier system.

To continue with the process 800, in step 809, the UE 116 calculates the CSI feedback based on received RS, e.g., channel quality indicator (CQI)/rank indicator (RI)/PMI. In one embodiment,

$${A}_{i} = \frac{{α}_{i} {γ}_{i}^{*}}{{α}_{1} {γ}_{1}^{*}} and {B}_{i} = \frac{{‖ {T}_{i}^{H} {g}_{2} ‖}^{2}}{{‖ {T}_{1}^{H} {g}_{1} ‖}^{2}} .$$

The objective of cross-TRP calibration is to estimate Aᵢ, especially the phase.

$${h}_{eff} = [ 1 , \frac{{α}_{2} {γ}_{2}^{*} {‖ {T}_{2}^{H} {g}_{2} ‖}^{2}}{{α}_{1} {γ}_{1}^{*} {‖ {T}_{1}^{H} {g}_{1} ‖}^{2}} , … , \frac{{α}_{K} {γ}_{K}^{*} {‖ {T}_{K}^{H} {g}_{K} ‖}^{2}}{{α}_{1} {γ}_{1}^{*} {‖ {T}_{1}^{H} {g}_{1} ‖}^{2}} ]$$

$${h}_{eff} = [ 1 , {A}_{2} {B}_{2} , … , {A}_{K} {B}_{K} ]$$

The UE 116 will perform PMI selection that can match the direction of the effective channel well. Denote the [symbol] th PMI vector as

[symbol]

=[1, [symbol] , . . . , [symbol] ]^{T}

Then, the selected PMI shall match h_{eff} well, i.e., the inner product is maximized:

$${ℓ}_{sel} = arg max {\vert {h}_{eff}^{H} {P}_{ℓ} \vert}^{2}$$

As a result, one may expect that ∠Aᵢ≈e^{θ}^{_{l,i}}. Note that in a multicarrier system, denote h_{eff,g} is denoted as the effective channel at subcarrier or RB q, where q=1, . . . , Q. And the procedure for the UE 116 to select PMI may be in principle written as

$${ℓ}_{sel} = arg max {\sum }_{q = 1}^{Q} {\vert {h}_{eff , q}^{H} {P}_{ℓ} \vert}^{2}$$

In an embodiment where two TRPs are utilized, a two TX codebook or two port codebook is configured. In another embodiment, α₁=α₂=1, i.e., no pre-distortion of the common phase and amplitude.

h_{eff}=[1,A₂B₂]

[symbol]

=[1, [symbol] ]^{T}

Note that B₂ is a positive real number. The selected PMI shall maximize|h_{eff}^{H} [symbol] | l or the phase [symbol] shall be closest to ∠A₂. Note that in the 2Tx code book, [symbol] ={0, 90, 180, 270} degree.

Having completed the previous step, in step 810, the UE 116 sends the CSI feedback (e.g., a PMI report) to gNB 102.

Although FIG. 8 illustrates a process 800 for signal flow for the calibration mechanism of the disclosed technology, various changes may be made to FIG. 8. For example, while shown as a series of steps, various steps in FIG. 8 could overlap, occur in parallel, occur in a different order, or occur any number of times.

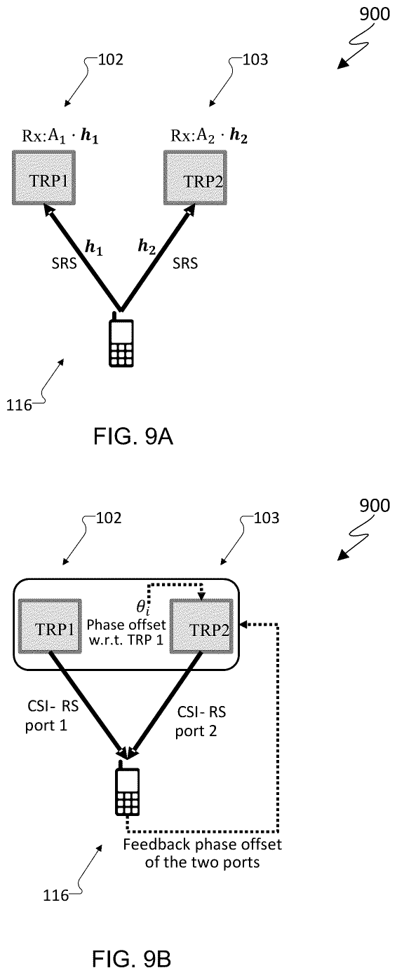

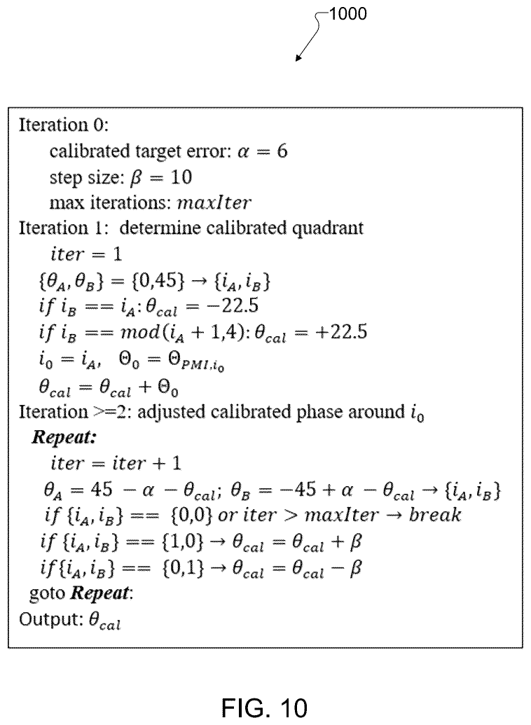

To get the relative phase of A₂B₂ from the example of FIG. 8, which is the phase offset between 2 TRPs, an algorithm is provided as illustrated in FIGS. 9A-9B and 10. The algorithm of FIGS. 9A-9B and 10 is described using two TRPs. However, if there are more TRPs that need to calibrate their phase offsets, the method can be applied via pair-wise calibration.

FIGS. 9A-9B illustrate an example of a process 900 of UE-aided calibration with two TRPS according to various embodiments of the present disclosure. The embodiment of UE-aided calibration with two TRPS of FIGS. 9A-9B is for illustration only. One or more of the components illustrated in FIGS. 9A-9B may be implemented in specialized circuitry configured to perform the noted functions or one or more of the components may be implemented by one or more processors executing instructions to perform the noted functions. Other embodiments of UE-aided calibration with two TRPS could be used without departing from the scope of this disclosure.

The example of FIGS. 9A-9B summarizes the basic steps 801-810 of FIG. 8, and an additional phase θᵢ is added to the conjugate beamforming vector w₂ of TRP2. Then based on PMI feedback reporting from UE, the NW adjusts phase θᵢ accordingly to calibrate the phase offset between two TRPs. The main calibration steps are summarized in FIG. 10.

As illustrated in FIGS. 9A, gNB 102 and gNB 103 measures respective channels via SRS. The UE 116 sends SRS to gNBs 102 and 103. Then, gNBs 102 and 103 send a beamformed CSI-RS to the UE 116, as illustrated in FIG. 8. This is performed, an iteration of N times, e.g., N=9, to obtain the phase of

$$x = \frac{{A}_{1}}{{A}_{2}}$$

via a virtualized 2Tx transmission and feedback. To do coherent joint transmission (CJT), the phase of

$$x = \frac{{A}_{1}}{{A}_{2}}$$

must be known. In the i^{th} iteration,

$${p}_{1} = {A}_{1}^{H} {h}_{1} / \vert {h}_{1} \vert \qquad Port 1$$

$${p}_{2} = {A}_{2}^{H} {e}^{j {θ}_{i}} {h}_{2} / \vert {h}_{2} \vert \qquad Port 2$$

Received signal at UE 116, e.g., 1 is sent, equates to

$${y}_{1} = {A}_{1}^{H} {h}_{1}^{H} \cdot {p}_{1} + {n}_{1} = {A}_{1}^{H} \vert {h}_{1} \vert + {n}_{1}$$

$${y}_{2} = {A}_{2}^{H} {e}^{j {θ}_{i}} \vert {h}_{2} \vert + {n}_{2}$$

two Tx Codebook (CB) wide beam (WB) PMI quantizes (A₁^{H}, A₂^{H}e^{jθ}^{ᵢ})˜(1, x^{H} e^{jθ}^{ᵢ}). By combining N such measurements, one may estimate the phase of x accurately.

Although FIGS. 9A-9B illustrate an example 900 of UE-aided calibration with two TRPS, various changes may be made to FIGS. 9A-9B. For example, while shown as a series of steps, various steps in FIGS. 9A-9B could overlap, occur in parallel, occur in a different order, or occur any number of times.

FIG. 10 illustrates pseudo code for an example of a process 1000 of UE-aided calibration with two TRPS according to various embodiments of the present disclosure. The embodiment of UE-aided calibration with two TRPS of FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of UE-aided calibration with two TRPS could be used without departing from the scope of this disclosure.

The example of FIG. 10 illustrates an algorithm that can produce a calibrated phase close to the true phase within any target calibration error α. This is an iterative algorithm with a phase adjusted step size β and maximum calibrated iterations maxlter. At each iteration, two CSI-RSs A, B with the adjusted phases {θ_{A}, θ_{B}} at TRP2 are transmitted similar as illustrated in FIGS. 9A-9B. Then based on two PMI feedbacks {i_{A}, i_{B}} from the UE, the quadrant (based on i₀) of the true phase is identified, and then calibrated phases are gradually adjusted with a step size β. Once the calibrated phase is close to a true phase within calibration error α, the algorithm converges. In example of FIG. 10, each iteration can comprise two or more CSIRS resource transmissions. The iterative UE-assisted calibration algorithm is described in more detail as follows.

For Iteration 1 a quadrant that is close to the true phase is determined.

In one embodiment, the two TRPs transmit 2-port CSIRS signals (CSIRS-A) with their computed conjugate beamforming without additional phase (θ_{A,1}=0). Then, the UE will send its PMI feedback based on its received signal in CSI-RS resource configuration i_{A,1}.

In one embodiment, to get a more reliable i_{A}, retransmission of the above CSIRS-A (θ_{A,2}=0) is performed. Then the UE will send its PMI feedback based on its received signal in CSI-RS resource configuration, namely i_{A,2}.

In one embodiment, after transmitting 2 CSIRS—As as above, if i_{A,1}==i_{A,2}, it can be determined if the true phase is close to UE PMI index i₀=L_{A,1}=i_{A,2}. If i_{A,1}≠i_{A,2}, t CSIRS-A needs to be transmitted to get more values of UE PMI indices i_{A}. Then i₀ can be chosen to be the most repeated i_{A} based on all the CSIRS-A transmissions.

In one embodiment, if UE PMI index is chosen i₀, it is known that the true phase is close to the angle Θ₀=Θ_{PMI,i}_{₀}.

In one embodiment, the two TRPs transmit 2-port CSIRS signals (CSIRS-B) with their computed conjugate beamforming without additional phase (θ_{B}=45o). Then the UE will send its PMI feedback based on its received signal in CSI-RS resource configuration, namely i_{B}.

In another embodiment, if i_{B}==i₀z, θ_{cal} is set to =Θ₀−22.5 or if i_{B}==mod (i₀+1,4), θ_{cal} is set to =Θ₀+22.5.

For Iteration >=2, the calibrated phase around Θ₀ is adjusted.

In one embodiment, the two TRPs transmit 2-port CSIRS signals (CSIRS-A) with their computed conjugate beamforming without additional phase (θ_{A}=45−α−θ_{cal}). Then the UE will send its PMI feedback based on its received signal in CSI-RS resource configuration, namely i_{A}.

In another embodiment, the two TRPs transmit 2-port CSIRS signals (CSIRS-B) with their computed conjugate beamforming without additional phase (θ_{B}=−45+α−θ_{cal}). Then the UE will send its PMI feedback based on its received signal in CSI-RS resource configuration, namely i_{B}.

In one embodiment, if {i_{A}, i_{B}}=={1,0}, t θ_{cal} is set to =θ_{cal}+β.

In one embodiment, if {i_{A}, i_{B}}=={0,1}, θ_{cal} is set to =θ_{cal}−β.

In one embodiment, if {i_{A}, i_{B}}=={0,0}, the calibrated phase is θ_{cal}=θ_{cal}+Θ₀, and the algorithm converges and exits.

In one embodiment, iteration >=2 is repeated up to maximum of maxlter or until {i_{A}, i_{B}}=={0,0}.

In another embodiment, the robustness of the calibration method can be increased by retransmitting {CSIRS-A, CSIRS-B} multiple times (or repeat Next Iteration while keeping θ_{cal} is unchanged as in the previous round) when the convergent condition {i_{A}, i_{B}}=={0,0} is satisfied. If the conversion condition is satisfied one more time, the algorithm converges and exit.

In another embodiment, after the convergent condition {i_{A}, i_{B}}=={0,0} is satisfied, Iteration >=2 is repeated, while keeping θ_{cal} unchanged as in the previous round. If the convergent condition is not satisfied as in the above embodiment, i_{A}, i_{B} is taken to be the most occurrant PMI indices of CSIRS-A, CSIRS-B transmissions in the above embodiment, respectively. Then Iteration >=2 is repeated until the algorithm converges, or the number of iterations exceeds maxlter.

Although FIG. 10 illustrates an example 1000 of UE-aided calibration with two TRPS, various changes may be made to FIG. 10. For example, while shown as a series of steps, various steps in FIG. 10 could overlap, occur in parallel, occur in a different order, or occur any number of times.

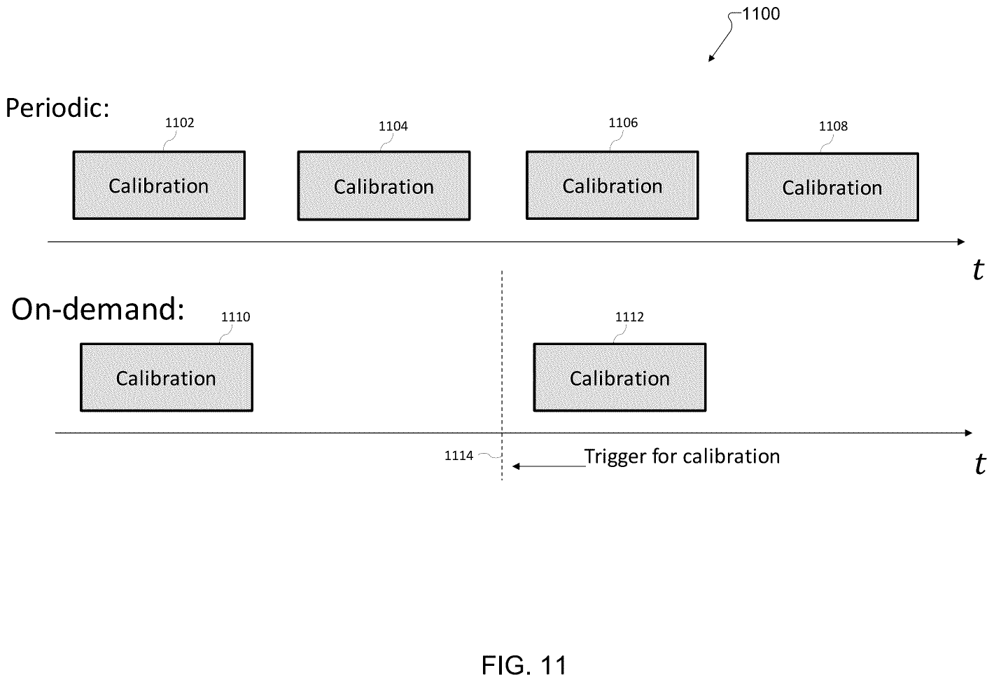

In one embodiment, calibration can be triggered on demand or on periodicity as shown on FIG. 11.

FIG. 11 illustrates an example 1100 of calibration triggering according to embodiments of the present disclosure. The embodiment of calibration triggering illustrated in FIG. 11 is for illustration only. Different embodiments calibration triggering could be used without departing from the scope of this disclosure.

In the example of FIG. 11, periodic calibrations 1102, 1104, 1106, and 1108 are triggered at regular intervals over a time period t. In another example, on-demand calibrations 1110 and 1112 are triggered in response to a trigger for calibration over time period t. For instance, calibration 1112 is triggered in response to trigger for calibration 1114.

Although FIG. 11 illustrates one example 1100 of calibration triggering, various changes may be made to FIG. 11. For example, the number of calibrations could change, the time t could change, etc., according to particular needs.

In one embodiment, check the robustness of the phase algorithm is regularly checked by running Iteration >=2 one or more times with CSIRS-A (θ_{A}=45−α−θ_{cal}) and CSIRS-B (θ_{B}=−45+α−θ_{cal}). If the UE PMI feedbacks received are {i_{A}, i_{B}}=={0,0}, then the algorithm passes the robustness check.

In another embodiment, if {i_{A}, i_{B}}≠{0,0} is received, and i_{A} ∈{0,1} and i_{B} ∈{0,1}, Iteration >=2 can be run for one or more iterations to correct the calibrated phase.

In another embodiment, if {i_{A}, i_{B}}≠{0,0} is received, and i_{A} ∈{2,3} or i_{B}∈{2,3}, the calibration algorithm is re-run from beginning, i.e., from Iteration 1.

In one embodiment, the calibration algorithm can be triggered on-demand for a maximum number of iterations as shown in FIG. 11. When the calibration algorithm converges, a regular robustness check can be performed in order to confirm the calibrated phase is correct, or the calibration procedures can be triggered from the beginning.

In another embodiment, the calibration algorithm can be triggered periodically.

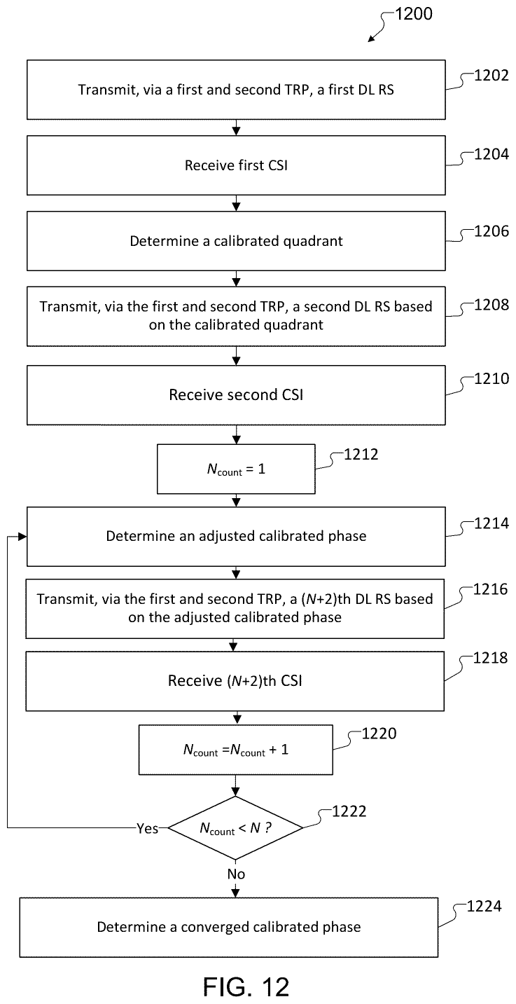

FIG. 12 illustrates a method 1200 for a first phase of a UE assisted phase calibration for distributed MIMO performed by a network entity according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of UE assisted phase calibration for distributed MIMO could be used without departing from the scope of this disclosure.

As illustrated in FIG. 12, the method 1200 begins at step 1202. At step 1202, a network entity such as gNB 102 or NE 104 of FIG. 1, transmits, via a first TRP and a second TRP, a first DL RS. At step 1204, the network entity receives, from a UE, first CSI. The first CSI is based on the first DL RS. At step 1206, the network entity determines a calibrated quadrant. The calibrated quadrant is determined based on the first CSI. At step 1208, the network entity transmits, via the first TRP and the second TRP, a second DL RS. At step 1210, the network entity receives, from the UE, second CSI. The second CSI is based on the second DL RS. At step 1212, the network entity begins to iterate the series of steps 1214-1222 for a number of iterations N. In the example of FIG. 12, the current iteration of N is represented by a counter N_{count}. At step 1214, the network entity determines an adjusted calibrated phase. The adjusted calibrated phase is based on the (N+1)th CSI. For example, in the first iteration, the adjusted calibrated phase is based on the 2nd CSI. At step 1216, the network entity transmits, via the first TRP and the second TRP, an (N+2)th DL RS. For example, in the first iteration, the network entity transmits a 3rd DL RS. The (N+2)th DL RS is based on the adjusted calibrated phased determined in step 1214. At step 1218, the network entity receives, from the UE, (N+2)th CSI. The (N+2)th CSI is based on the (N+2)th DL RS. For example, in the first iteration the network receives 3rd CSI based on the 3rd DL RS. The current iteration of N is completed at step 1220. At step 1222, if additional CSI reports are needed, the process proceeds back to step 1214 to begin another iteration. If the number of CSI reports are sufficient, the process proceeds to step 1224. At step 1224, the network entity determines a converged calibrated phase. The converged calibrated phase is based on the most recently received (N+2)th CSI. For example, if three iterations have been completed, the converged calibrated phase is based on the 5th CSI.

Although FIG. 12 illustrates one example of a method 1200 for a first phase of a UE assisted phase calibration for distributed MIMO, various changes may be made to FIG. 12. For example, while shown as a series of steps, various steps in FIG. 12 could overlap, occur in parallel, occur in a different order, or occur any number of times.

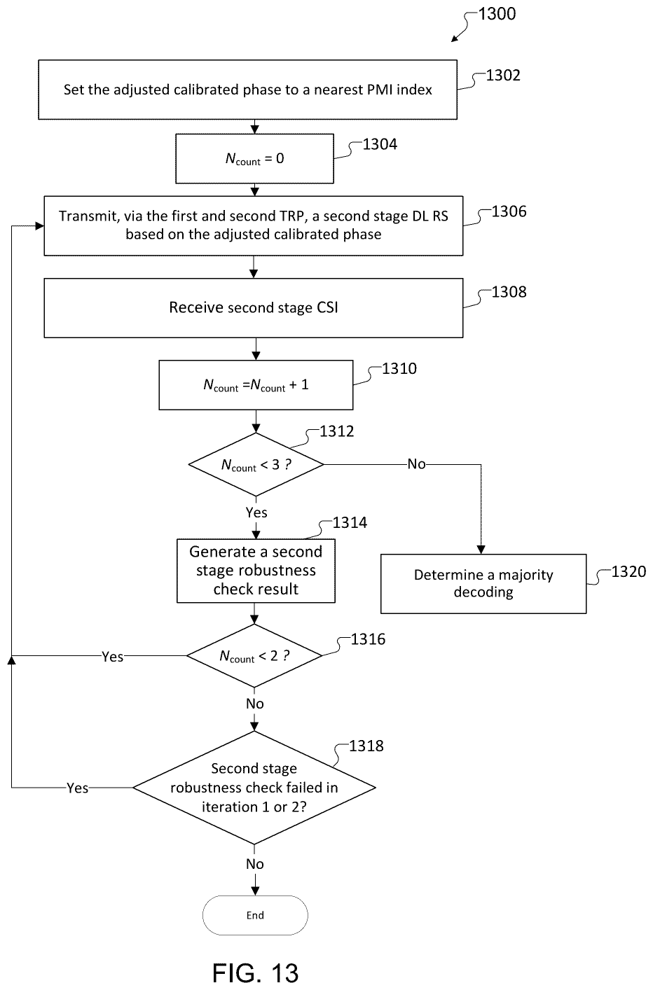

FIG. 13 illustrates a method 1300 for a second phase of a UE assisted phase calibration for distributed MIMO performed by a network entity according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of UE assisted phase calibration for distributed MIMO could be used without departing from the scope of this disclosure.

As illustrated in FIG. 13, the method 1300 begins at step 1302. At step 1302, a network entity such as gNB 102 or NE 104 of FIG. 1, sets the adjusted calibrated phase to a nearest PMI index. At step 1304, the network entity begins to iterate the series of steps 1306-1312 for a number of iterations N. In the example of FIG. 13, the current iteration of Nis represented by a counter N_{count}. At step 1306, the network entity transmits, via the first TRP and the second TRP, a second stage DL RS. The second stage DL RS is based on the adjusted calibrated phase. At step 1208, the network entity receives, from a UE, second stage CSI. The second CSI is based on the second stage DL RS. The current iteration of N is completed at step 1310. At step 1312, if the present iteration is either iteration 1 or iteration 2, the method proceeds to step 1314. Otherwise, the method proceeds to step 1320. At step 1314, the network entity generates a second stage robustness check result. At step 1316, if the current iteration is iteration 1, the process proceeds back to step 1306 to begin another iteration. If current iteration is iteration 2, at step 1318 the network entity determines whether the second stage robustness check for either iteration 1 or iteration 2 indicates that a second stage robustness check is failed. If the second stage robustness check for either iteration 1 or iteration 2 indicates that a second stage robustness check is failed, the process proceeds to back to step 1306 to begin another iteration. Otherwise, the process ends. At step 1320, the network determines a PMI result based on a majority decoding of the second stage CSI received over the iterations.

Although FIG. 13 illustrates one example of a method 1300 for a second phase of a UE assisted phase calibration for distributed MIMO, various changes may be made to FIG. 13. For example, while shown as a series of steps, various steps in FIG. 13 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A network entity comprising:
a memory; and
a processor operably coupled to the memory, the processor configured to:
perform a calibration operation,
wherein to perform a first stage of the calibration operation the processor is further configured to:
transmit, via a first TRP and a second TRP, a first downlink (DL) reference signal (RS);
receive from a user equipment (UE), based on the first DL RS, first channel state information (CSI);
determine, based on the first CSI, a calibrated quadrant;
transmit, via the first TRP and the second TRP, a second DL RS based on the calibrated quadrant;
receive from the UE, based on the second DL RS, second CSI; and
determine, based on the second CSI, a converged calibrated phase.

2. The network entity of claim 1, wherein:
the first DL RS comprises a first and a second CSI-RS;
the first CSI comprises a first and a second PMI report;
the second DL RS comprises a third and a fourth CSI-RS; and
the second CSI comprises a third and a fourth PMI report.

3. The network entity of claim 1, wherein:
the first DL RS comprises a first CSI-RS;
the first CSI comprises a first PMI report;
the second DL RS comprises a second CSI-RS; and
the second CSI comprises a second PMI report.

4. The network entity of claim 1, wherein the processor is further configured to:
determine whether a time period has elapsed,
wherein the calibration operation is performed based on a determination that the time period has elapsed.

5. The network entity of claim 1, wherein the processor is further configured to:
receive a trigger for calibration,
wherein the calibration operation is performed based on receiving the trigger for calibration.

6. The network entity of claim 1, wherein the processor is further configured to:
generate, based on a first stage robustness check, a first stage robustness check result;
if the first stage robustness check result indicates the first stage robustness check is failed, repeat the first stage of the calibration operation; and
if the first stage robustness check result indicates that the first stage robustness check is passed, perform a second stage of the calibration operation.

7. The network entity of claim 6, wherein to perform the second stage of the calibration operation the processor is further configured to:
set an adjusted calibrated phase to a nearest PMI index;
for two iterations:
transmit, via the first TRP and the second TRP, a second stage DL RS based on the adjusted calibrated phase; and
receive from the UE, based on the second stage DL RS, second stage CSI,
wherein after each of the two iterations, a second stage robustness check result is generated, based on the second stage CSI; and
after the two iterations:
if the second stage robustness check result indicates that a second stage robustness check is failed for at least one of the two iterations, perform a third iteration, and determine a PMI result based on a majority decoding of the second stage CSI received over the iterations.

8. A user equipment (UE) comprising:
a processor configured to generate channel state information (CSI); and
a transceiver operably coupled to the processor,
wherein to perform a first stage of a calibration operation the transceiver is configured to:
receive, via a first TRP and a second TRP, a first downlink (DL) reference signal (RS);
transmit, based on the first DL RS, first channel state information (CSI);
receive, via the first TRP and the second TRP, a second DL RS based on a calibrated quadrant; and
transmit, based on the second DL RS, second CSI.

9. The UE of claim 8, wherein:
the first DL RS comprises a first and a second CSI-RS;
the first CSI comprises a first and a second PMI report;
the second DL RS comprises a third and a fourth CSI-RS; and
the second CSI comprises a third and a fourth PMI report.

10. The UE of claim 8, wherein:
the first DL RS comprises a first CSI-RS;
the first CSI comprises a first PMI report;
the second DL RS comprises a second CSI-RS; and
the second CSI comprises a second PMI report.

11. The UE of claim 8, wherein the calibration operation is performed based on a determination that a time period has elapsed.

12. The UE of claim 8, wherein the transceiver is further configured to:
if a first stage robustness check result indicates a first stage robustness check is failed, repeat the first stage of the calibration operation; and
if the first stage robustness check result indicates that the first stage robustness check is passed, perform a second stage of the calibration operation.

13. The UE of claim 12, wherein to perform the second stage of the calibration operation the transceiver is further configured to:
for two iterations:
receive, via the first TRP and the second TRP, a second stage DL RS based on an adjusted calibrated phase; and
transmit, based on the second stage DL RS, second stage CSI; and
after the two iterations:
if a second stage robustness check result indicates that a second stage robustness check is failed for at least one of the two iterations, perform a third iteration.

14. A method of operating a network entity comprising:
performing a calibration operation,
wherein performing a first stage of the calibration operation comprises:
transmitting, via a first TRP and a second TRP, a first downlink (DL) reference signal (RS);
receiving from a UE, based on the first DL RS, first channel state information (CSI);
determining, based on the first CSI, a calibrated quadrant;
transmitting, via the first TRP and the second TRP, a second DL RS based on the calibrated quadrant;
receiving from the UE, based on the second DL RS, second CSI; and
determining, based on the second CSI, a converged calibrated phase.

15. The method of claim 14, wherein:
the first DL RS comprises a first and a second CSI-RS;
the first CSI comprises a first and a second PMI report;
the second DL RS comprises a third and a fourth CSI-RS; and
the second CSI comprises a third and a fourth PMI report.

16. The method of claim 14, wherein:
the first DL RS comprises a first CSI-RS;
the first CSI comprises a first PMI report;
the second DL RS comprises a second CSI-RS; and
the second CSI comprises a second PMI report.

17. The method of claim 14, further comprising:
determining whether a time period has elapsed,
wherein the calibration operation is performed based on a determination that the time period has elapsed.

18. The method of claim 14, further comprising:
receiving a trigger for calibration,
wherein the calibration operation is performed based on receiving the trigger for calibration.

19. The method of claim 14, further comprising:
generating, based on a first stage robustness check, a first stage robustness check result;
if the first stage robustness check result indicates the first stage robustness check is failed, repeating the first stage of the calibration operation; and
if the first stage robustness check result indicates that the first stage robustness check is passed, performing a second stage of the calibration operation.

20. The method of claim 19, performing the second stage of the calibration operation comprises:
set an adjusted calibrated phase to a nearest PMI index;
for two iterations:
transmit, via the first TRP and the second TRP, a second stage DL RS based on the adjusted calibrated phase; and
receive from the UE, based on the second stage DL RS, second stage CSI,
wherein after each of the two iterations, a second stage robustness check result is generated, based on the second stage CSI; and
after the two iterations:
if the second stage robustness check result indicates that a second stage robustness check is failed for at least one of the two iterations, perform a third iteration, and determine a PMI result based on a majority decoding of the second stage CSI received over the iterations.
